(19) United States
(12) Patent Application Publication
(10) Pub. No.: US 2008/0042859 A1
(43) Pub. Date: Feb. 21, 2008

(54) Ventilation control device

(76) Inventors: Jennifer E. Dufour, Macomb, MI (US); William T. Dufour, Macomb, MI (US)

Correspondence Address: Warn, Hoffmann, Miller & LaLone, P.C., P.O. Box 70098, Rochester Hills, MI, 48307, US

(21) Appl. No.: 11/502,035

(22) Filed: Aug. 10, 2006

(51) Int. Cl. G08B 17/10

(52) U.S. Cl. 340/632

(57) ABSTRACT

The present invention is directed to a ventilation control device having a portable housing capable of being selectively positioned in various locations in a space such as a room, vehicle compartment or any other area where people or animals may be located. The ventilation control device has a gas detection portion within the portable housing capable of sensing the presence of a specified gas or gasses. A transmitter is also located within the portable housing and operably engaged to the gas detection portion for transmitting a ventilation signal. A power source is located within said portable housing for energizing said transmitter. The power source can be an independent power source such as a battery or a connector such as plug for connecting to power outside of the portable housing or both. A connection portion is located on the portable housing for removably connecting the portable housing at a user specified location.

### FIELD OF THE INVENTION

The present invention relates to a portable gas detection and ventilation control device.

### BACKGROUND OF THE INVENTION

The buildup of unwanted gasses in structures such as homes and vehicles can lead to harmful or even deadly consequences. However, the use and creation of sometimes fatal gasses is often unavoidable because they are byproducts of our everyday life. For example buildings and vehicles almost always contain the presence of carbon monoxide and carbon dioxide produced from the combustion of natural gas, gasoline or other fuel sources. In order to try and combat the problem of unwanted buildup of these gasses ventilation systems are often installed. However, detection devices for harmful gasses are often not present in all areas. When detection devices are present they are often not positioned in an ideal location in a given space. Thus there is a need to provide a detection device that is versatile in terms of positioning and is capable of controlling the ventilation of the unwanted gasses. Also detection devices can be implemented in a variety of settings so it is necessary for them to have versatility in terms of programming and power supply sources.

### SUMMARY OF THE INVENTION

The present invention is directed to a gas control device having a portable housing capable of being selectively positioned in various locations in a space such as a room, vehicle compartment or any other area where people or animals may be located. The gas control device has a gas detection portion within the portable housing capable of sensing the presence of a specified gas or gasses. A transmitter is also located within the portable housing and operably engaged to the gas detection portion for transmitting a signal that can actuate a ventilation device or an alarm. A power source is located within the portable housing for energizing the transmitter. The power source can be an independent power source such as a battery or a connector such as plug for connecting to power outside of the portable housing or both. A connection portion is located on the portable housing for removably connecting the portable housing at a user specified location.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of the ventilation control device;

FIG. 2 is a cross-sectional view of an alternate embodiment of the ventilation control device;

FIG. 3 is a cross-sectional illustration of the ventilation control device being used in a garage;

FIG. 4 is a cross-sectional illustration of the ventilation control device activating a garage door in response to the presence of gas within the garage; and

FIG. 5 is a partially broken away cross-sectional plan view of an alternate embodiment of the invention.

### DETAILED DESCRIPTION OF THE PREFERRED EMBODIMENTS

The following description of the preferred embodiment(s) is merely exemplary in nature and is in no way intended to limit the invention, its application, or uses.

Referring now to FIG. 1 which shows a perspective view of the portable gas control device 10 shown in accordance with the present invention. Gas control device 10 has a housing 12 that has a sensor or gas detection portion 14 contained within the portable housing 12 for sensing the presence or absence of a specific gas or gasses. The types of unwanted gas that can be sensed by the gas detection portion 14 are virtually unlimited and include, but are certainly not limited to, smoke, carbon dioxide, carbon monoxide, oxygen, propane, radiation, methane, or radon.

Also contained within the portable housing 12 is a transmitter 16 that is operably engaged to the gas detection portion 14. The transmitter 16 serves to transmit a signal from the portable housing 12 to a device. The signal transmitted by the transmitter 16 can be transmitted with or without hard wires. Thus it is within the scope of this invention for radio frequency waves or some other non-wire transport to be used for outputting the signal from the portable housing 12. The signal transmitted by the transmitter 16 can be any type of signal. The signal can be a ventilation control signal that is transmitted out of the portable housing 12 to a device. The signal can also be an alarm signal that is transmitted outside of the portable housing 12 to an alarm device that provides an audible and or visual alarm. Another aspect of the invention provides an alarm device integrated within the portable housing 12. The transmitter 16 would transmit an alarm signal within the portable housing 12 to the alarm device.

The transmitter 16 in the present embodiment is contained within the portable housing 12. The transmitter 16 can have a learning circuit that allows the transmitter to learn the gas signal for operating the gas device. For example, in a application where the gas control device 10 is being used in a garage, the transmitter 16 can be programmed to learn and then subsequently transmit a wireless garage door signal.

The portable housing 12 also contains a power source 18a, 18b for providing the power needed to operate the gas detection portion 14 and the transmitter 16. The power source 18a, 18b can be self-contained with the portable housing 12 and be in the form of a battery 18a or can be in the form of a connector 18b for connecting the gas control device 10 to an outside power source. For example, it is possible to mount the gas control device 10 to a wall or some other location near a power outlet. It is also possible for the gas control device to have one or more sources of power. For example the ventilation control device can have a battery 18a that is charged using an outlet 18b. In the alternate the battery 18a can be used a backup in case there is a loss of electrical power at the connector 18b.

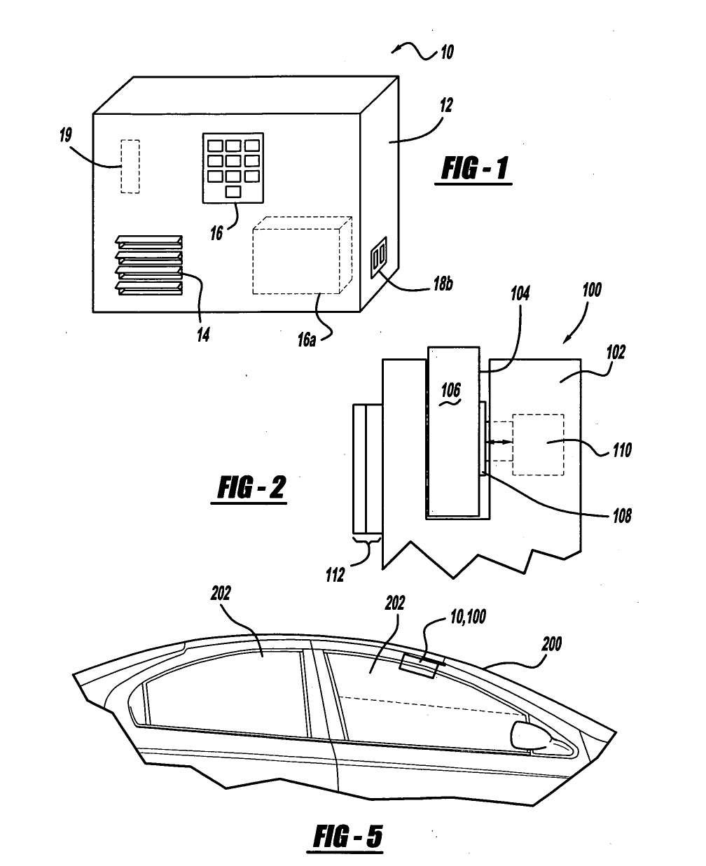

Referring to FIG. 2 an alternate embodiment of a gas control device 100 is shown. In this particular embodiment the gas control device 100 has a housing 102 that has an opening 104 for receiving a removable transmitter 106. The removable transmitter 106 has an actuation button 108 that when depressed will transmit a ventilation signal. In one embodiment of the invention the transmitter 106 can be a garage door opening having a button 108 that transmits a wireless signal to a garage door opener. However, it is within the scope of this invention for the transmitter to be any type of wired or wireless transmitter for operating a gas device. A mechanical piston 110 is contained within the housing 102 and is aligned to depress the button 108 of the transmitter 106. This particular embodiment of the invention allows the gas control device 100 to be more easily configured with already existing systems or openers such as garage doors or other transmitting devices. In this embodiment all a user has to do in order to set up the gas control device 100 is place a transmitter 106 within the aperture 104 and no further configuration will be needed.

FIG. 2 also shows a connection portion 112 which is used to removably connect the portable housing 102 at a user specified location. This connection portion 112 can be used in conjunction with all embodiments of the invention described herein. For example, the gas control device 10 can have a connection portion 112 located on its surface for connecting the gas control device 10 at a user specified location. The connection portion 112 can be a type of fastener, Velcro, mounting bracket, tape or adhesives or any other suitable connection. Additionally, the connection portion can be magnets for connecting the portable housing 12, 102 to a metal object.

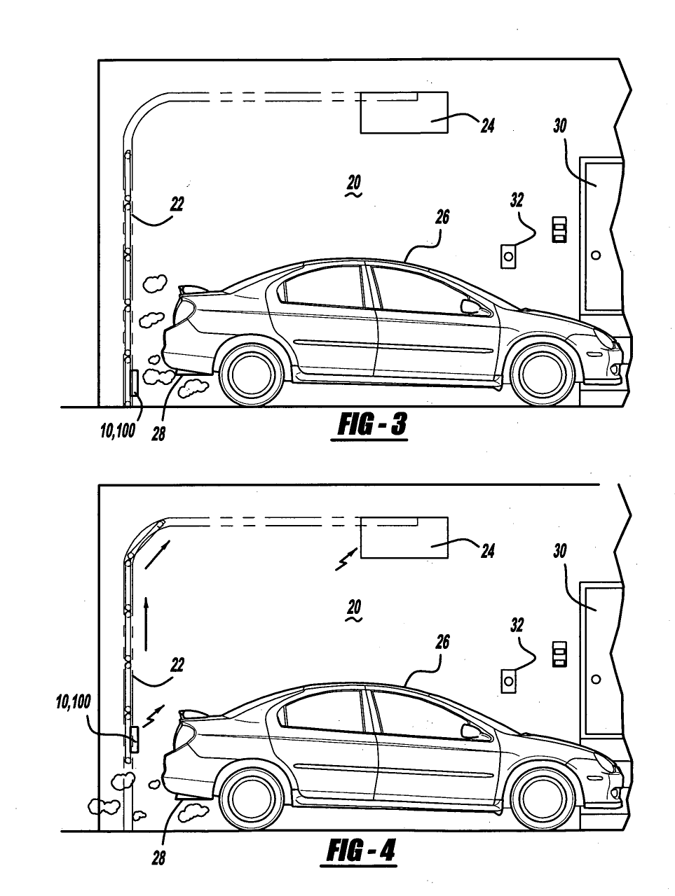

Referring now to FIGS. 1-4 the operation of the gas control devices 10, 100 will now be described. FIGS. 3 and 4 show a garage 20 with a garage door 22 operably connected to a garage door opener 24. A car 26 with a tailpipe 28 located in the garage 20. The gas control device 10, 100 is connected to the garage door 22 using the connection portion 112. However, it is possible to connect the gas control device 10, 100 at a location other than the garage door 22. The gas control device 10, 100 can be positioned at any desired height with the garage 20 because of the portability of the device.

As shown in FIG. 3 and FIG. 4 the gas control device 10, 100 is positioned at or near the height of the tailpipe 28 of the vehicle 26. In FIG. 3 the garage door 22 is shown in the closed position initially when the car 26 is first started. The gas control device 10, 100 senses the presence of unwanted gas, such as carbon monoxide or carbon dioxide from the tailpipe 28 and transmits a signal to the garage door opener. In FIG. 4 the unwanted gas is ventilated as the garage door 22 is moved to the open position in response to the transmission of a ventilation signal from the ventilation control device 10, 100.

The present invention allows for the selective positioning of the gas control device 10, 100 at a specified location. The application shown in FIG. 3 and FIG. 4 the gas control device 10, 100 is positioned near the level of the tailpipe 28 of the vehicle 26. This provides a tremendous response time since the gas control device 10, 100 is positioned so close to the source of the unwanted gas. If a gas control device were not positioned this close to the source, but instead were positioned near an interior house door 30 or near a wall outlet 32 the garage 20 would have to fill up with a much higher amount of unwanted gas before being detected. This may not be a fast enough response time and could still present a dangerous situation. The present invention solves these problems.

Additionally, it is within the scope of the invention to incorporate the ventilation control device in other settings. For example, it is not necessary that the ventilation device be a garage door opener 24 in combination with a garage door 22. It is within the scope of this invention for the ventilation device to be a window opener or ventilation fan. Furthermore, the present invention is not limited to being used within a garage 20. It is possible to use the present invention in virtually any other type of room, vehicle, or other setting.

The gas control device 10 can be equipped with a sensor 19 that provides a means for sensing whether or not a ventilation device has been activated such as a mechanical switch, a gyroscope, proximity sensor, or electronic circuitry such as a memory circuit or any other sensing device capable of remembering or determining whether or not a ventilation device has been activated. The sensor is necessary in order to prevent a ventilation device from accidentally moving from a vent position to a closed vent position. Additionally, the sensor 19 could be separate from the portable housing 12 which would allow the sensor 19 to be placed separate from the gas control device 10. This would require the sensor 10 to the be able to transmit a signal to the gas control device 10.

FIG. 5 shows an embodiment where the gas control device 10, 100 is incorporated within the interior of a vehicle 200. In this particular embodiment of the invention the gas control device 10, 100 is placed within the interior cabin of the vehicle and if the presence of an unwanted gas is sensed by the gas control device 10, 100 the transmitter will transmit a signal that will automatically roll down the windows 202 of the vehicle 200. In this embodiment of the invention it is possible for the gas control device 10, 100 to be pre-installed within the interior of the vehicle 200 and connected so that signals from the transmitter 18 are sent via hardwires to the window actuators (not shown). However it is within the scope of this invention for the gas control device 10, 100 to be sold as an aftermarket device so it can be positioned anywhere within the cabin of the vehicle 200. Not only is it possible to use this invention in automobiles it is also within the scope of this invention to use the portable gas control device 10, 100 in other vehicles such as boats and recreational vehicles.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A control device comprising:
a portable housing;
a gas detection portion within said portable housing capable of sensing the presence of a specified gas or gases;
a transmitter within said portable housing operably engaged to said gas detection portion for transmitting a signal;
a power source within said portable housing for energizing said transmitter; and
a connection portion on said portable housing for removably connecting said portable housing at a user specified location.

2. The control device of claim 1 wherein said gas detection portion is capable of sensing the presence of one or more gasses selected from the group comprising:
smoke, carbon dioxide, carbon monoxide, oxygen, propane, radiation, methane or radon.

3. The control device of claim 1 wherein said signal is a ventilation signal for actuating at least one selected from a group comprising a door opener, window opener or ventilation fan.

4. The gas control device of claim 1 further comprising an alarm that is activated when gas detection portion senses said specified gas or gases.

5. The control device of claim 4 wherein said alarm is located outside of said portable housing and receives a signal from said transmitter.

6. The control device of claim 1 wherein said transmitter transmits a wireless signal.

7. The control device of claim 1 wherein said transmitter transmits a signal using hard wires connected between said transmitter and an actuated a device.

8. The control device of claim 1 wherein said power source is a connecter that receives power from outside said portable housing.

9. The control device of claim 1 wherein said power source is a battery contained within said portable housing.

10. The control device of claim 1 wherein said connection portion has one or more magnets for removably connecting said portable housing to a metallic object.

11. The control device of claim 1 wherein said connection portion is one selected from the group comprising a fastener, Velcro™, mounting bracket, tape or adhesives.

12. The control device of claim 1 further comprising a means for sensing whether or not a device has been activated by said signal generated by said transmitter.

13. A control device comprising:
a portable housing;
a gas detection portion within said portable housing capable of sensing the presence of a specified gas;
a transmitter holder within said portable housing for securing a transmitter capable of transmitting a signal;
an actuator connected to said transmitter holder and selectively configured to actuate said transmitter to transmit said signal when said actuator receives an actuation signal from said gas detection portion;
a power source within said portable housing for energizing said transmitter; and
a connection portion on said portable housing for removably connecting said portable at a users specified location.

14. The control device of claim 13 wherein said transmitter holder can be used to hold multiple transmitters or programmed to operate different devices.

15. The control device of claim 13 wherein said actuator is a mechanical piston configured to selectively press a button on said transmitter in response to a signal received from said gas detection portion.

16. The control device of claim 13 wherein said gas detection portion is capable of sensing the presence of one or more gasses selected from the group comprising:
smoke, carbon dioxide, carbon monoxide, propane, oxygen, radiation, methane or radon.

17. The control device of claim 13 wherein said signal is a ventilation signal for actuating at least one selected from a group comprising a door opener, window opener, ventilation fan.

18. The control device of claim 13 wherein said transmitter transmits a wireless signal.

19. The control device of claim 13 wherein said transmitter transmits a signal using hard wires connected between said transmitter and an actuated device.

20. The control device of claim 11 wherein said power source is a connector that receives power from outside said portable housing.

21. The control device of claim 11 wherein said power source is a battery contained within said transmitter.

22. The control device of claim 12 wherein said power source supplies power to said gas detection portion and said actuator.

23. The control device of claim 12 wherein said connection portion has one or more magnets for removably connecting said portable housing to a metallic object.

24. The control device of claim 12 wherein said connection portion is one selected from a group comprising a fastener, Velcro™, mounting bracket, tape or adhesives.
